(19) United States
(12) Patent Application Publication
(10) Pub. No.: US 2014/0244312 A1
(43) Pub. Date: Aug. 28, 2014

(54) SYSTEMS AND METHODS FOR PROVIDING INSURANCE INFORMATION EXCHANGE

(71) Applicant: UNITED SERVICES AUTOMOBILE ASSOCIATION, San Antonio, TX (US)

(72) Inventors: Emily Gray, San Antonio, TX (US); Sharon Haverlah, Bulverde, TX (US); Bradley Billman, San Antonio, TX (US); Andre Buentello, San Antonio, TX (US); Gunjan C. Vijayvergia, San Antonio, TX (US); Minya Liang, McKinney, TX (US); Gina Smith, Boerne, TX (US)

(21) Appl. No.: 13/840,661

(22) Filed: Mar. 15, 2013

Related U.S. Application Data
(60) Provisional application No. 61/768,339, filed on Feb. 22, 2013.

(51) Int. Cl. G06Q 40/08

(52) U.S. Cl. CPC G06Q 40/08
USPC 705/4

(57) ABSTRACT

A computer-implemented method for collecting and transmitting data relating to an insurable incident. First data and second data relating to the incident is collected with at least one device. A data package is formed by combining the first data and second data such that the first data is visible and the second data is obscured by the first data. The package is transmitted to an insurance provider.

### RELATED APPLICATION

The present application claims the benefit of co-pending U.S. Provisional Patent Application No. 61/768,339, filed Feb. 22, 2013, the entire contents of which is incorporated herein by reference.

### BACKGROUND

When an insurance event, such as an accident between two vehicles, occurs, a long process of data exchange occurs. The individuals involved in the accident commence the process by exchanging identity and insurance information (e.g. names, addresses, policy numbers, etc.). The individuals transmit this information to their insurance providers along with details about the accident. The insurance providers then begin their own data collection processes. Simultaneously, third parties, such as law enforcement, repair shops, and car rental agencies require access to information regarding the accident. Much of time, outmoded or conventional forms of communications (e.g. telephone, paper, and pen) are utilized to perform such data exchange and collection. This makes the data exchange and collection process unreliable and inefficient. Therefore, improved systems and methods for the exchange, transmission, and collection of data surrounding insurance events are needed to correct these deficiencies.

### BRIEF DESCRIPTION OF THE DRAWINGS

So that those having ordinary skill in the art, to which the present invention pertains, will more readily understand how to employ the novel system and methods of the present invention, certain illustrated embodiments thereof will be described in detail herein-below with reference to the drawings, wherein:

FIG. 1 depicts one embodiment of an insurance information exchange;

FIG. 2 depicts one embodiment of the exchange device depicted in FIG. 1;

FIG. 3 depicts one embodiment of an application for exchanging data between mobile communication devices;

FIG. 4 depicts a data package that may be used in the system of FIG. 1;

FIGS. 5 depicts a process of using the insurance information exchange of FIG. 1.

A component or a feature that is common to more than one drawing is indicated with the same reference number in each of the drawings.

### DETAILED DESCRIPTION OF CERTAIN EMBODIMENTS

The present disclosure is directed to systems and methods for the exchange, transmission, and collection of data in the below illustrated embodiments. It is to be appreciated the subject invention is described below more fully with reference to the accompanying drawings, in which illustrated embodiments of the present invention are shown. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated that certain embodiments of this invention as discussed below are a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

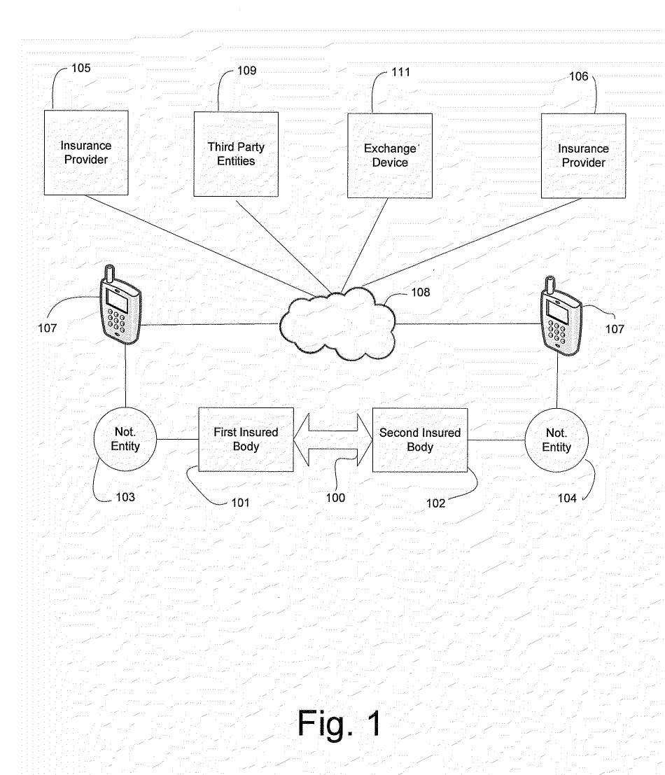

Referring to FIG. 1, a representation of an exemplary insurable event 100 is depicted for illustrative purposes. Event 100 in one example involves a first insured body 101 and a second insured body 102. In one embodiment, first insured body 101 and second insured body 102 are moving vehicles, such as automobiles. In another embodiment, first insured body 101 and second insured body 102 include a moving vehicle and a stationary structure, such as a building. It should be noted, however, that the depiction of event 100 as including multiple insured bodies is provided for illustrative purposes. As will be clear from this disclosure, an event 100 may include only a single insured body 101, 102. For example, an automobile may veer off the road and strike a non-insured structure, or a building may incur an insurable event through weather or a fire.

Referring further to FIG. 1, each insured body 101, 102 includes a notification entity 103, 104 and an insurance provider 105, 106. A notification entity 103, 104 in one example is an individual or entity that is present when event 100 occurs and notifies an insurance provider 105, 106 about an event occurring with regard to insured body 101, 102. An example of a notification entity 103, 104 would include a driver of an automobile or an occupant of a building. In another example, a notification entity 103, 104 is an individual who is not present when event 100 occurs, but notifies insured body 101, 102 of such event because such individual has an interest in an insured body 101, 102. For instance, such a notification body may be an owner of an insured body 101, 102 or a holder of an insurance policy covering insured body 101, 102. A notification entity 103, 104 may also be a sensor or device, such as a telematics impact sensor, a traffic camera, etc.

Each notification entity 103, 104 in one example communicates with insurance provider 105, 106 to provide insurance provider 105, 106 with information about event 100. It should be noted that notification entity 103, 104 may communicate with an insurance provider 105, 106 through utilization of one or more devices 107 over a network 108. Notification entities 103, 104 and insurance providers 105, 106 may also elect to communicate directly with each other.

A device 107 generally includes at least one processor, at least one data interface, and at least one memory device coupled via buses. A device 107 may be coupled to another device 107 or to peripheral devices. FIG. 1 depicts devices 107 as standalone for illustrative purposes. Multiple devices 107 may be coupled and function together as further described herein as part of a distributed processing environment. An exemplary device is a computing device, such as mobile device (e.g. cell phones, smart phones, etc.), personal computers, notebook computers, tablet computers, servers, etc. Devices 107 may communicate with each other directly or over a network 108.

Network 108 may include a local area network (LAN) and/or a wide area network (WAN), but may also include other networks such as a personal area network (PAN). Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules may be stored in a remote memory storage device such as storage medium. Devices 107 may communicate over network 108 through one or more communications links. Communication links may be wired (e.g. Ethernet, USB, Firewire, etc.) or wireless (e.g. Bluetooth, 802.11, 3GPP, 3GPP2, etc.) or a combination thereof. Devices 107 may also communicate with each other through other wireless technologies as (RFID, IrDA, barcodes) or use communications applications, such as Bump.

In one embodiment, device 107 may be integrated into an insured body 101, 102. For instance, device 107 may be part of an automobile or a building and notification entity 103, 104 may utilize device 107 to contact an insurance provider 105, 106. In a further example, notification entity 103; 104 may be a device. For instance, notification entity 103, 104 may be a device that is integrated into an automobile or building that is responsible for automatically notifying insurance provider 105, 106 when an event occurs. For example, a telematics system that can communicate with an insurance provider 105, 106 when event 100 occurs. In another example, device 107 may be fire detection circuitry in a building that is capable of notifying insurance provider 104, 105 when a fire occurs.

Referring further to FIG. 1, insurance provider 105 in one example is an entity that has a relationship with a respective insured body 101, 102 such that it agrees to provide insurance benefits to a policy holder in the event that a particular event occurs with respect to such respective insured body 101, 102. Insurance provider 105, 106 in one example utilizes one or more devices 107 to communicate with a notification entity 103, 104 over network 108.

Still referring to FIG. 1, there may also be third party entities 109 associated with event 100. Such third party entities 109 may include law enforcement agencies, first responders, witnesses, and the like. Third party entities 109 do not necessarily have any material interest in insured body 101, 102 or event 100, but do have information relevant to event 100. Such information may be of interest to notification entities 103, 104 or insurance provider 105, 106. Third party entities 109 may communicate with insured bodies 101, 102, notification entities 103, 104, and/or insurance providers 105, 106 through utilization of devices 107. It should be noted that third party entities 109 may comprise a device that is configured and programmed to communicate and exchange information with notification entities 101, 102 and insurance providers 105, 106 when an event 100 occurs. For instance, a third party entity 109 may be a traffic camera, a surveillance camera, a traffic light, a GPS device, a source of weather data, a source of traffic data, etc. In response to a query from an insured body 101, 102, notification entities 103, 104, and/or insurance providers 105, 106, such devices 107 may provide information to insured bodies 101, 102 notification entities 103, 104, and/or insurance providers 105, 106. Alternatively, such devices may automatically exchange information with insured bodies 101, 102 notification entities 103, 104, and/or insurance providers 105, 106. Examples of such devices may be found in U.S. Pat. Nos. 7,701,355 and 8,289,160, which are hereby incorporated by reference in their entirety.

Referring further to FIG. 1, in one embodiment, an exchange device 111 is provided. Exchange device 111 in one example is a device 107 that is programmed and configured to exchange information with insured bodies 101, 102, notification entities 103, 104, insurance providers 105, 106, and/or third party entities 109. Exchange device 111 in one embodiment provides a mechanism through which insurance information may be held in a standard format that is accessible by entities with a need to know such data. For instance, insured bodies 101, 102, notification entities 103, 104, insurance providers 105, 106, and/or third party entities 109 may elect to subscribe to a provider of exchange device 111 such that they can access insurance information or personal information on an as needed basis. In one embodiment, this would allow individual entities, such as insured bodies 101, 102 to own data (e.g. telematics data) and elect to share the data with the owner or operator of the exchange device 111. The exchange device 111 could provide access to insurance information to those entities by using different level of security access, as will be described further herein.

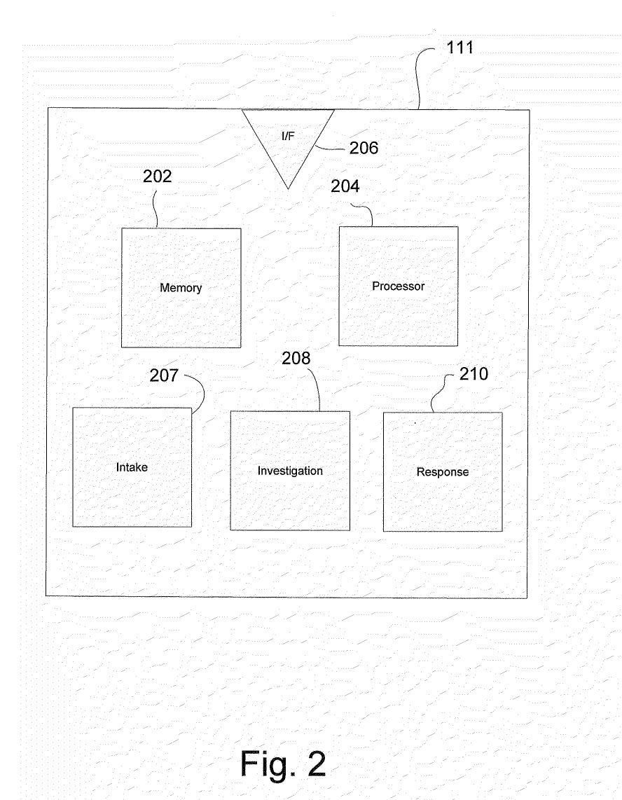

Referring to FIG. 2, exchange device 111 in one example includes a memory device 202, a processor 204, at least one data interface 206, intake engine 207, investigation engine 208, and response engine 210.

Memory device 202 in one example comprises a computer-readable signal-bearing medium. One example of a computer-readable signal-bearing medium for system comprises a recordable data storage medium, such as a magnetic, electrical, optical, biological, and/or atomic data storage medium. In another example, a computer-readable signal-bearing medium comprises a modulated carrier signal transmitted over a network coupled with exchange. In one example, memory device 202 includes a series of computer instructions written in or implemented with any of a number of programming languages, as will be appreciated by those skilled in the art.

Memory device 202 in one embodiment includes exchange database 203. In another embodiment, exchange database 203 resides elsewhere, such as on one or more devices 107 associated with insured bodies 101, 102 notification entities 103, 104, and/or insurance providers 105, 106. Exchange database 203 in one embodiment comprises information about event 100. In one example, the information includes information collected from and about insured bodies 101, 102, notification entities 103, 104, insurance providers 105, 106, third party entities 109, and/or event 100 itself. Such information may include, but is not limited to names, IDs, policy numbers, vehicle information, structural information, dates, times, weather data, GPS data, location information, video, pictures, witness information, historical data relating to the location of event 100, and or historical information related to insured bodies 101, 102, notification entities 103, 104, third party entities 109 (e.g. past claims).

Processor 204 is an electronic device configured of logic circuitry that responds to and executes instructions. Processor 204 may comprise more than one distinct processing devices, for example to handle different functions within exchange device 111. Processor 204 may output results of an execution of the methods described herein to an output device connected to interface 206. Alternatively, processor 204 could direct the output to another device via network 104.

At least one data interface 206 may include the mechanical, electrical, and signaling circuitry for communicating data over network 108. Interface 206 may be configured to transmit and/or receive data using a variety of different communication protocols and various network connections, e.g., wireless and wired/physical connections. Interface 206 may include an input device, such as a keyboard, a touch screen or a speech recognition subsystem, which enables a user to communicate information and command selections to processor 204. Interface 206 may also includes an output device such as a display screen, a speaker, a printer, etc. Interface 206 may include an input device such as a touch screen, a mouse, track-ball, or joy stick, which allows the user to manipulate the display for communicating additional information and command selections to processor 204.

The term “engine” with reference to intake engine 207, investigation engine 208, and response engine 210 denotes a functional operation that may be embodied either as a stand-alone component or as an integrated configuration of a plurality of subordinate components. Thus, intake engine 207, investigation engine 208, and response engine 210 may be implemented as a single module or as a plurality of modules that operate in cooperation with one another. Moreover, intake engine 207, investigation engine 208, and response engine 210 may be implemented as software instructions in memory 202 or separately in any of hardware (e.g., electronic circuitry), firmware, software, or a combination thereof. intake engine 207, investigation engine 208, and response engine 210 contain instructions for controlling processor 204 to execute the methods described herein. Examples of such methods are explained below.

Referring further to FIG. 2, intake engine 207 provides the functionality by which information relating to event 100 is provided to exchange device 111. In one exemplary embodiment one or more participants, such as one or all of insured bodies 101, 102, notification entities 103, 104, insurance providers 105, 106, and third party entities 109 may access the exchange device 111 over network 108 through utilizing a browser or dedicated application. Intake engine 207 exchanges information with such participants. Intake engine 207 may query the participants or provide the participant with predetermined menus or fields that allow the user to provide information about event. Intake engine 207 may request that investigation engine 208 validate this information. For example, investigation entity may connect may connect to third party entities 109 over network 108 to determine if the information is correct. An example would include investigation engine connecting to a server of a weather data provider to validate that weather information provided by the participant is correct. In another example, investigation engine may utilize traffic camera data to verify that accident information provided by the participant is correct. Upon receiving data from participants, intake engine 207 will organize and store a record of event 100 in database 203.

Investigation engine 208 in one embodiment provides the functionality by which exchange device 111 researches information about event 111. Investigation engine 208 in one example includes application-programming interfaces (APIs) that allow investigation engine 208 to pull data from third party entities 109 such that an information can be validated as discussed above. Such APIs may include the ability to access weather data, traffic data, social media data, historical data (e.g. accident records), GPS data, telematics data, etc. In another example, investigation engine 208 may use data in memory 202 to validate information. Investigation engine 208 may also contact participants through other means, such as email, voicemail, social media, SMS, and telephone. In another example, investigation engine 208 may use the preceding methods of contact to obtain information from insured bodies 101, 102, notification entities 103, 104, and/or insurance providers 105, 106. Upon receipt of such information intake engine 207 will store and organize the information in memory 202.

Response engine 210 in one example provides the functionality by which exchange device 111 responds to a request for event 100. In one example, a response may be insurance provider 105 requesting information about event 100 such that insurance provider may process a claim. For instance, if insured bodies 101, 102 were automobiles and event 100 were an automobile crash, insurance provider 105 may contact exchange device 111 to request available information relating to the accident. Response engine 210 would then provide the available information to insurance provider 105. In another example, response engine 210 may determine that additional information is needed and request investigation engine 208 to perform additional research regarding event 100.

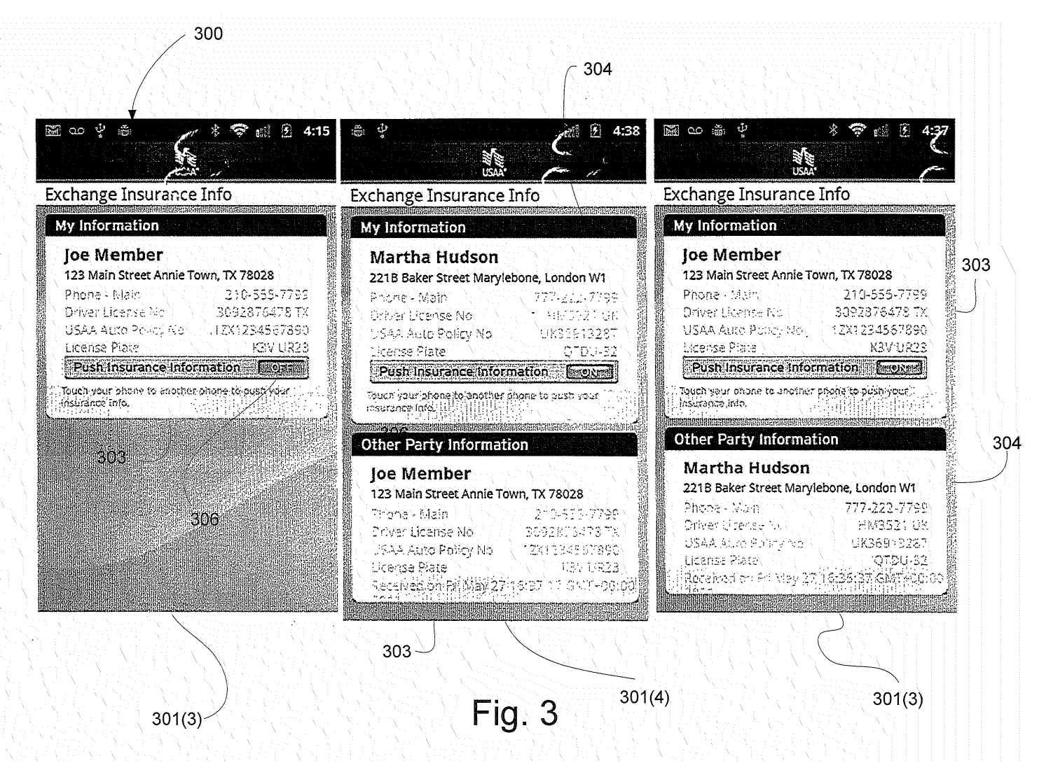

Referring to FIG. 3, an exemplary user interface 300 is shown. Interface 300 is depicted as displays 301(3) and 301(4) on devices 107 for illustrative purposes. Display 301(3) corresponds to notification entity 103 and display 301(4) corresponds to notification entity 104. Interface 300 allows notification entities 103, 104 to exchange information about event 100. Display 301(3) has insurance policy information 303 about notification entity 103, and display 301(4) has insurance policy information 304 about notification entity 104. An actuation button 306 allows the notification entity 103 or 104 to actuate a push exchange of information. If the actuation button 306 is in an “on” condition, then date exchange will occur. Such data exchange may occur over network 108 or through peer to peer communication (e.g. Bluetooth, RFID, IrDA, Bump, etc.) When data exchange occurs, information 303 appears on display 301(4) and information 304 appears on display 301(3). Notification entities 103, 104 can then transmit information 303 and/or information 304 to insurance provider 105, insurance provider 106, third party entities 109, and/or exchange device 111.

Referring further to FIG. 3, in one example, a confirming entity may receive information 303, 304 and verify whether or not such information 303, 304 is correct. For instance, notification entities 103, 104 may transmit information 303 and/or information 304 to insurance provider 105, insurance provider 106, third party entities 109, and/or exchange device 111 for confirmation that information 303, 304 is correct. Alternatively, the devices 107 holding displays 301(3), 301(4) could be pre-populated with libraries of insurance data and serve as confirming entities. Such libraries may be provided to devices 107 by insurance providers 105, 106 or exchange device 111. If information 303, 304 is found not to be accurate, then a notification entity 103, 104 will be notified by whatever entity and can take corrective action, such as requesting correct information or notifying third party entities 109 (e.g. law enforcement) that incorrect information was provided.

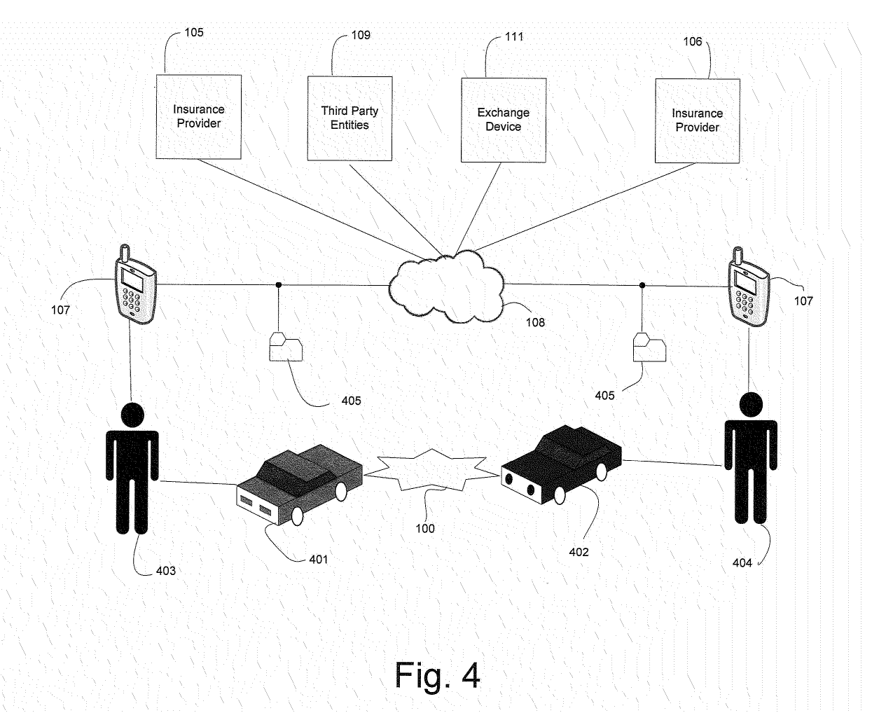

Referring to FIG. 4, an exemplary description of a way by which notification entities 103, 104, insurance providers 105, 106, and/or exchange device 111 may communicate is provided for illustrative purposes. In one example, an event 100 occurs. In the example shown, the event 100 is an automobile accident between two automobiles 401, 402 driven by individuals 403, 404. When event 100 occurs, one or both of individuals 403, 404 (who in this case are each a notification entity—see FIG. 1) begin to collect information about event 100. Such information may include, but is not limited to, policy information, weather information, vehicle information, GPS information, date information, time information, audio information, and/or video information. Such information may be collected by individuals 403, 404 through utilization of a device 107. For instance, individuals 403, 404 may utilize device to take pictures, collect time and data information, and collect GPS coordinates using a smartphone. A notification entity 403, 404 may also use a device to collect information from third party sources 109.

Referring further to FIG. 4, in one example, when data collection is complete or when individual 403, 404 decides to transmit data to another party, individual 403, 404 commences an operation by which the data is formatted into a package 405 for transmission. In one example, the data is formatted by attaching it as metadata to a photograph of event. The package 405 is then sent over network 108 to insurance providers 105, 106, and/or exchange device 111, which can then disassemble the package 405 by extracting the metadata from photograph. The individuals 403, 404 could also exchange data between themselves by exchanging information in packages 405. In another example, individuals 403, 404 may combine their information into a single package 405 and send it over network 108 to insurance providers 105, 106, and/or exchange device 111.

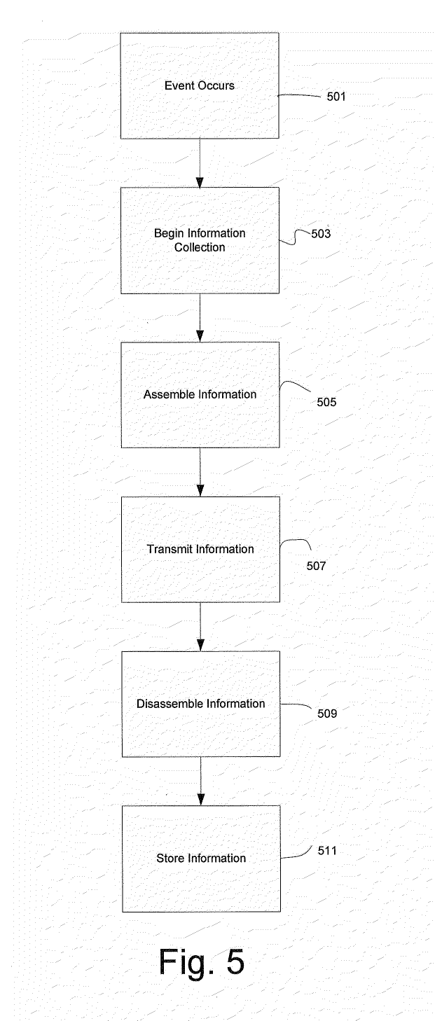

Referring to FIG. 5, an exemplary flow diagram of process by which event 100 information is collected and communicated is now provided for exemplary purposes. In step 501, event 100 occurs. Event 100 may include a vehicle accident, a vehicle fire, a vehicle breakdown, etc. Event 100 may also include an event that occurs to a stationary structure, such as a building fire or damage due to a catastrophic event.

In step 503, one or both of notification entities 103, 104 begin to collect information about event 100. Notification entities 103, 104 may be participants in event 100 (e.g. drivers of automobiles) or may be interested parties (e.g. policy holders). Collection of information may include using a device 107 to document event 100. For instance, a notification entity 103, 104 may take pictures, notes, or recordings that document event 100. In another example, notification entity 103, 104 may contact third party entities 109 to collect information about event 100. For example, a notification entity 103, 104 may access weather sites, traffic cameras, other vehicles (e.g. witness vehicles) and GPS data to provide information about event 100. In a further example, notification entities 103, 104 may exchange information utilizing the system shown in FIG. 3.

In step 505, the information about event 100 is assembled for transmission. In one example, the information is assembled by wrapping the information and encrypting the information into package 401 (FIG. 4.) For instance, the information may be attached as metadata to a picture of the aftermath of event 100. This package 401 may then be encrypted. In one example, the package 401 comprises a standardized format of data payload (e.g. XML). In another example, the package 401 comprises an Insurance Exchange Data Format (IEDF). Exemplary fields included in such a standardized IEDF format would include Name, Address, Phone No., GPS Location, Insurance ID, Insurance Company Name, Image, and Video fields.

In step 507, package 401 is transmitted over network 108. In one example, package is sent to an insurance provider 105, 106. In another example, package 401 is sent to a third party entity 109. In a further example, package is sent to exchange device 111.

In step 509, the receiving entity disassembles the package 401. In one example, the receiving entity disassembles the package 401 by decrypting package 401 and extracting the metadata from the picture included therein.

In step 511, the receiving entity stores the information for further use by interested parties, such as law enforcement, insurance providers, and other interested parties. In one embodiment, the receiving entity may verify that the information is authentic and/or correct. For instance, the receiving entity may contact those involved in the incident, witnesses, and/or third parties to verify the data. The receiving entity may elect periodically to verify the information to insure the integrity of incident data. It should also be noted that the receiving entity may choose to limit or provide access to the data based on the identity or profile of a requesting entity. For example, law enforcement may have access to all data relating to an incident whereas participants in the incident or other third parties may have access to only some data.

Further, the access level may be set by others rather then the receiving entity. For instance, the sender of the data to the receiving entity may set the access level.

It should be noted that by implementing the methods described herein, the receiving entity may provide a common standard and clearing house through which multiple insurance companies. law enforcement agencies, individuals, and other interested parties may securely communicate details regarding individuals and/or incident.

It should be noted that the exchange of data described with reference to FIGS. 1-5 may accomplished in variety of ways to protect against unauthorized use or exploitation of the data. For instance, data may be protected with digital rights management (DRM) such that the data has a limited time or a limited number of times for which the data can be accessed. In another example, data may be provided to a secure site, from which insured bodies 101, 102, notification entities 103, 104, and third party entities 109 may access the data after identify verification. In other example, insured bodies 101, 102, notification entities 103, 104, and third party entities 109 may exchange a token that can be utilized for a limited amount of time, a limited frequency, or a limited purpose to access data.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention.

What is claimed is:

1. A computer-implemented method for collecting and transmitting data relating to an insurable incident, comprising:
collecting first data and second data relating to the incident through utilization of at least one device;
forming a data package by combining the first data and second data such that the first data the second data is embedded in the first data; and
transmitting the package to an insurance provider.

2. The computer-implemented method of claim 1, wherein the step of collecting the first data comprises taking an image relating to the incident.

3. The computer-implemented method of claim 2, wherein the step of collecting the second data comprises collecting non-image data.

4. The computer-implemented method of claim 2, wherein the step of forming a package comprises adding the second data as metadata to the image.

5. The computer-implemented method of claim 1, wherein the step of collecting comprises a party to the incident collecting one of the first data or the second data.

6. The computer-implemented method of claim 5, wherein the step of collecting further comprises a party not involved in the incident collecting data.

7. A computer-implemented method for storing data relating to an insurable incident, comprising:
receiving data relating to the incident, wherein the data is formatted in accordance with an insurance exchange data format (IEDF) standard;
storing the data for access by parties with a need to access such data.

8. The computer-implemented method of claim 7, wherein IEDF standard comprises Name, Address, Phone No., GPS Location, Insurance ID, Insurance Company Name, Image, and Video fields.

9. The computer-implemented method of claim 7, wherein the step of receiving data comprises receiving data that is generated through utilization of mobile communications device from one or more parties involved in the incident.

10. The computer implemented method of claim 9, wherein the step of receiving data comprises receiving data that is generated by one or more witnesses to the incident.

11. The computer implemented method of claim 9, wherein the step of receiving data comprises receiving data that is generated by one or more first responders to the incident.

12. The computer implemented method of claim 9, wherein the step of receiving data comprises receiving data that is generated by at least one of a traffic data source, a weather information source, a traffic camera, a traffic light, and a telematics data source.

13. The computer implemented method of claim 7, wherein the insurable incident is an automobile accident.

14. The computer implemented method of claim 7, wherein the insurable incident is a fire occurring with respect to a structure.

15. A computer-implemented method for exchanging data relating to an insurable incident, comprising:
a first party to the incident collecting first party information through utilization of a first mobile communications device, wherein the first party information is displayed on the first party mobile communications device;
a second party to the incident collecting second party information through utilization of a second mobile communications device; wherein the second party information is displayed on the mobile communications device;
the first party and second party an initiating an exchange of the first party data and the second party data; wherein the first party information and the second party information is displayed on both the first mobile communications device and the second mobile communications device in response to the first party and the second party initiating the exchange.

16. The computer-implemented method of claim 15, further comprising one of the first party and the second party sending the first party information and the second party information to an insurance provider.

17. The computer-implemented method of claim 16, wherein the first party sends the first party information and the second party information to the insurance provider in accordance with an Insurance Exchange Data Format (IEDF) standard.

18. The computer-implemented method of claim 15, wherein the first party and the second party communicate in accordance with Bluetooth.

19. The computer-implemented method of claim 15, wherein the first party and second party communicate in accordance with RFID.

20. The computer-implemented method of claim 15, wherein the step of the first party and second party initiating the exchange comprises the first party and second party bringing the first mobile communications device and the second mobile communications device in a predetermined proximity to each other.
